(19) United States
(12) Patent Application Publication
(10) Pub. No.: US 2009/0132313 A1
(43) Pub. Date: May 21, 2009

(54) Human resource management system

(75) Inventors: Kevin Chandler, New South Wales (AU); Fiona Brown, New South Wales (AU)

Correspondence Address: WOOD, PHILLIPS, KATZ, CLARK & MORTIMER, 500 W. MADISON STREET, SUITE 3800, CHICAGO, IL, 60661, US

(73) Assignee: Chandler MacLeod Limited

(21) Appl. No.: 12/221,950

(22) Filed: Aug. 7, 2008

(30) Foreign Application Priority Data
Nov. 21, 2007 (AU) 2007237201

(51) Int. Cl. G06Q 10/00

(52) U.S. Cl. 705/7

(57) ABSTRACT

This invention concerns a human resource management system, designed in particular, for recruitment selection, personnel management and career guidance. In a first aspect the invention is a computer system, in a second aspect a computer operated method, and in a third aspect software for performing the method. The invention involves a database to store descriptions of jobs each of which is defined by competencies. A database to store descriptions of candidates each of which is defined by competencies. A processor operable to automatically report a ranked match between a single job and many candidates based on matching competencies, or to automatically report a ranked match between a single candidate and many jobs based on matching competencies. And, a user interface to display the resulting report.

### TECHNICAL FIELD

This invention concerns a human resource management system, designed in particular, for recruitment selection, personnel management and career guidance. In a first aspect the invention is a computer system, in a second aspect a computer operated method, and in a third aspect software for performing the method.

### BACKGROUND ART

Human resources are the most valuable assets of any organisation. The success of an organisation relies heavily on having employees with the necessary competencies to help achieve business goals and improve competitive advantage. It is therefore important that people with the right knowledge, skill and temperament be recruited, trained, retained and promoted. Existing recruitment systems mostly focus on candidate screening at the time of hire. Human resource (HR) managers or recruitment agents usually gather as much information as possible about potential recruits through interviews and background checks. However, candidates usually come from vast educational and professional backgrounds, making it difficult for recruiters to assess and compare their suitability effectively. Even when hired after a rigorous selection process, a policy must be in put place to help employees develop in their roles, and to identify future roles that they can progress into.

Likewise many individuals need assistance finding a suitable career path outside the structure of an organisation. This can be true of students who do not have a great deal of work experience, unemployed individuals who have found it hard to find employment in a particular area, or even employed individuals who are not satisfied with there current career choice. These individuals often find that they need assistance to see how well they suit their job preferences as well as locate other suitable career options that they might not have considered before.

### DISCLOSURE OF THE INVENTION

In one aspect, the invention is a computer system for recruitment selection, personnel management and career guidance, comprising:
A database to store descriptions of jobs each of which is defined by competencies.
A database to store descriptions of candidates each of which is defined by competencies.
A processor operable to automatically report a ranked match between a single job and many candidates based on matching competencies, or to automatically report a ranked match between a single candidate and many jobs based on matching competencies.
A user interface to display the resulting report.

It is therefore an advantage of the invention that candidates can be assessed and compared in a qualitative and quantitative manner based on their competencies. For example, a recruitment manager may use the invention to compare job candidates and shortlist a group of candidates with the best percentage fit for interview. By providing an interface to assess candidates systematically, the invention helps to speed up the recruitment process and improves the accuracy of the hiring decision. A candidate in either case may be a potential or existing employee. Further, the invention is able to help candidates find suitable jobs. After a job has been found it is able to help an employee advance their career into new positions. The invention may be used by the candidate or employee directly, or by their career advisor.

In a report of a ranked match between a single job and many candidates, candidates may be ranked according to a percentage fit of their competencies with that of a job. Similarly, in a report of a ranked match between a single candidate and many jobs, jobs may be ranked according to a percentage fit of their competencies with that of a candidate.

The report of a ranked match between a single candidate and many jobs may be selectively filtered to show only results that match the candidate's interests. The interests of the candidate may be assessed by requesting the candidate to rate interests according to their preference for different types of work. Once an initial list of interest preferences has been derived they may be used to filter the list of job options and only show those that match the candidate's interests. These results are shown to the candidate in the context of their percentage fit with each job via an interface. The candidate can then edit their interest preferences via this interface using a list of all interest categories provided.

Job seekers and other individuals requiring career guidance, such as students, may use the interface to find jobs that best match their competencies and interests. Similarly, existing employees may use the invention to assess their suitability with existing and future roles. By identifying roles that employees can progress into and are likely to perform well in, the invention may then facilitate internal progression and staff development.

The processor may be further operable to provide for each job a full breakdown of the candidate's fit with each of the individual competencies allocated as either essential or desirable for that particular job. This breakdown may provide a description of each competency, a description of the candidate's result on that competency, and a section outlining interview and referee questions for an employer to use to confirm a particular result. The breakdown will also identify gaps between the competencies of the job and the competencies of a candidate. For each competency gap the system may provide development advice (in terms training that can be provided either through specific courses or on-the-job) and placement advice to an employment consultant or employer. By providing additional information in relation to the candidate's competency gaps, managers may then design or select tailored training and development programs to help their employees to bridge those gaps. Such personal development programs in turn help high performance employees to achieve their full potential and contribute successfully to organisational strategic goals. Others, such as teachers, career advisors and job placement consultants can also use this information to locate training programs for job seekers so that when they apply for a job they can demonstrate that they meet the employers skill requirements.

The processor may be further operable to report competency strengths of a single candidate. This report helps a candidate to assess their competency strengths and see that they do have skills that employer's value. This report is important for job seekers (who have been unemployed for a long period of time) and students (who have not yet been a part of the workforce) as a self-esteem builder and means of illustrating that they do have something to offer an employer. It may also be used as a feedback report in the selection/recruitment context to provide the candidate with a broad positive overview of the information the system derived about them.

The system may further comprise a user interface for candidates to take a number of assessment tasks. It is from the candidate's results on these assessment tasks that a candidate's competency results are derived. An assessment task may comprise one or more questions, each having plural answer choices. Assessment tasks may be categorised into ability- and temperament-type tasks.

Assessment tasks are tests that are designed to assess a candidate's ability and temperament. Each assessment task may comprise one or more questions and answer choices and in some tasks questions are grouped into one or more subtasks. A question may require more than one answer.

At the beginning of each ability assessment task sample questions may be provided to ensure the candidate understands what they must do before they begin the assessment.

In a conventional assessment task or test the same questions may be administered to all candidates. Alternatively, questions may also be selected via a structured process from a pool of questions. In this case candidates may receive different sets of pre-programmed ‘strings’ of questions. The candidate's experience will remain unchanged since they will still receive what looks like a conventional test. However, each candidate will receive a different item string thus enabling these tests to be administered unproctored.

By using item response theory to analysis the item pool it is possible to produce tests that are more precise in terms of their measurement accuracy.

Observance of behaviour during a test and statistical analysis may be used when the assessment is administered unproctored. For example, algorithms maybe included that provide an estimate of the result's reliability. Unproctored testing has the advantage that candidates may take the tasks anywhere and anytime without creating a resource drain on task administrators.

The system may further comprise a user interface for creating and editing descriptions of jobs in the database in terms of competencies. Descriptions of jobs contained in standardised job classification systems such as the Australian Standard Classification of Occupations (ASCO) may be used.

The invention may be used by recruitment agencies, career advisors, schools and colleges and government agencies. This invention is extremely beneficial to schools who do not have the time, resources or expertise to provide individualised career guidance. The invention may also be used by candidates who are not happy in their current role and wish to have a career change.

In another aspect, the invention is computer implemented method for recruitment selection, personnel management and career guidance, comprising the steps of:
Storing descriptions of jobs each of which is defined by competencies.
Storing descriptions of candidates each of which is defined by competencies.
Automatically reporting a ranked match between a single selected job and many candidates based on matching competencies, or automatically reporting a ranked match between a single selected candidate and many jobs based on matching competencies.
Displaying the resulting report at a computer interface.

In a further aspect the invention is a software program to implement the method.

### BRIEF DESCRIPTION OF THE DRAWINGS

An example of the invention will now be described with reference to the accompanying drawings, in which:

FIG. 1 is a recruitment selection, personnel management and career guidance system exemplifying the invention.

FIG. 2 is a database entity relationship diagram.

FIG. 3 is a web user interface of Profile Management Module.

FIG. 4 is a competencies table of an exemplary job.

FIG. 5 is a screenshot of Profiler Module.

FIG. 6 is a screenshot of a training exercise.

FIG. 7 is a process flowchart of generating a Candidate Strengths Report.

FIG. 8 is a sample Job Options Report.

FIG. 9 is a process flowchart of generating a Job Options Report.

FIG. 10 is a screenshot of Interest Filter Wizard.

FIG. 11 is a process flowchart of generating a filtered Job Options Report.

FIGS. 12 and 13 show a sample Job Fit and Development Report.

FIG. 14 is a sample Candidate Shortlist Report.

FIG. 15 is a process flowchart of generating a Candidate Shortlist Report.

### BEST MODES OF THE INVENTION

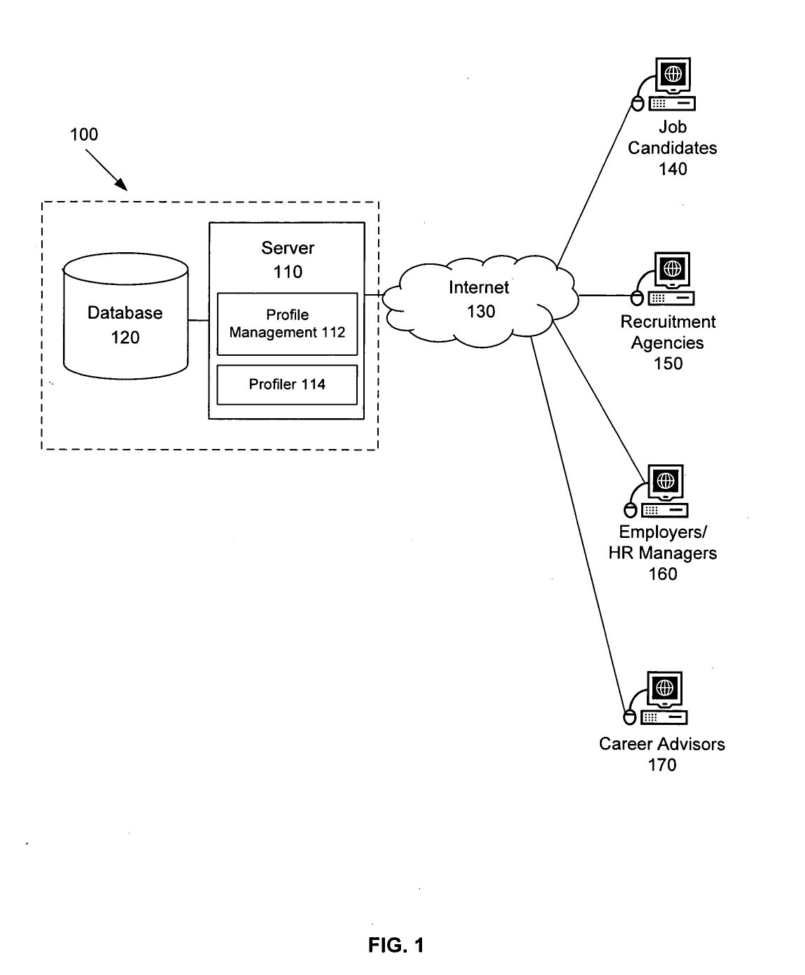

Referring first to FIG. 1, the recruitment selection, personnel management and career guidance system 100 comprises a server 110 and a database 120 in communication with plural users via the Internet 130. A user may be a job candidate 140, a recruitment agent 150, an employer or HR manager 160 or a career advisor 170. The system 100 may interface with the finance systems or human resource systems such as SAP HR and PeopleSoft HR, job boards and applicant tracking systems (ATS).

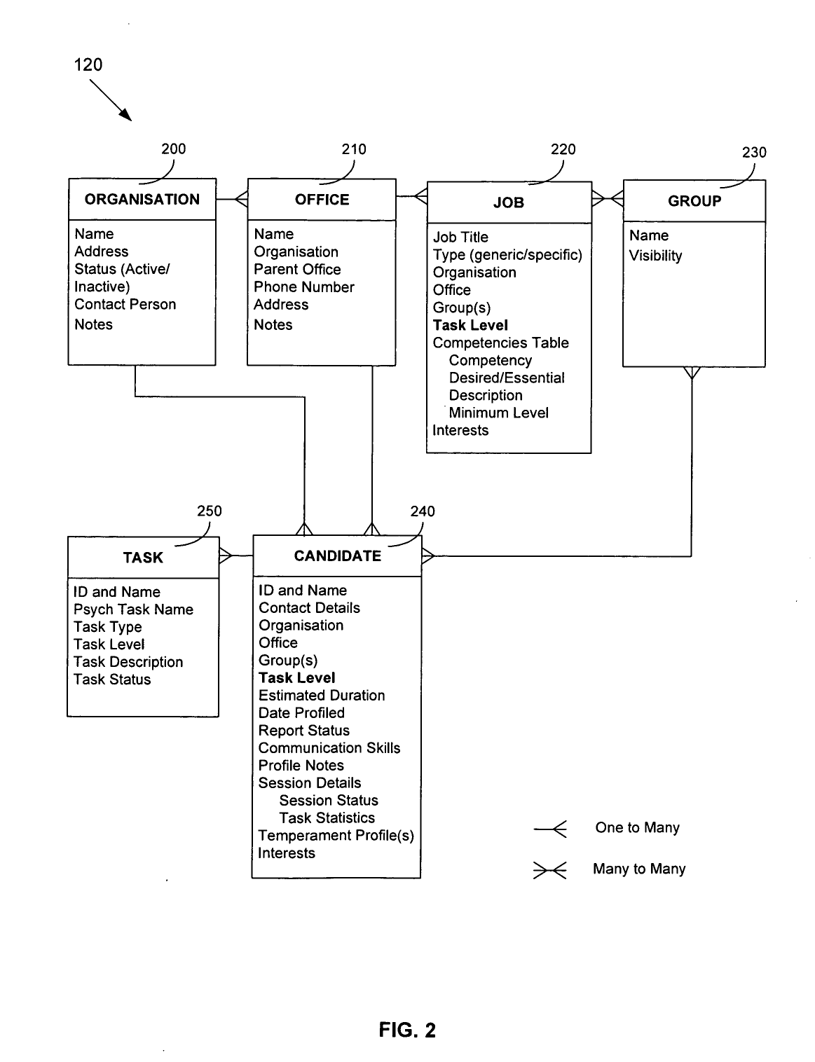

Referring now to FIG. 2, database 120 stores entities that are related to human resource activities in an organisation. Typically, an organisation 200 comprises one or more physical offices 210, each having plural job profiles 220 and candidate profiles 240. Each job profile 220 and candidate profile 240 are characterised by a task level representing whether the candidate can be compared to skilled or professional (or both) jobs. Candidates 240, who may be potential or existing employees, are profiled using assessment tasks that are automatically set according to their task level.

The server 110 provides two modules for users to manage entities in the database 120. Profile Management Module 112 is used by managers, recruiters or career advisors to create and manage job and candidate profiles; to provide career advice based on a candidate's competencies; to assess the training requirements of candidates; and to generate reports. On the other hand, Profiled Module 114 is used by candidates to take assessment tasks unproctored, or under the supervision of a task administrator.

### Profile Management Module 112

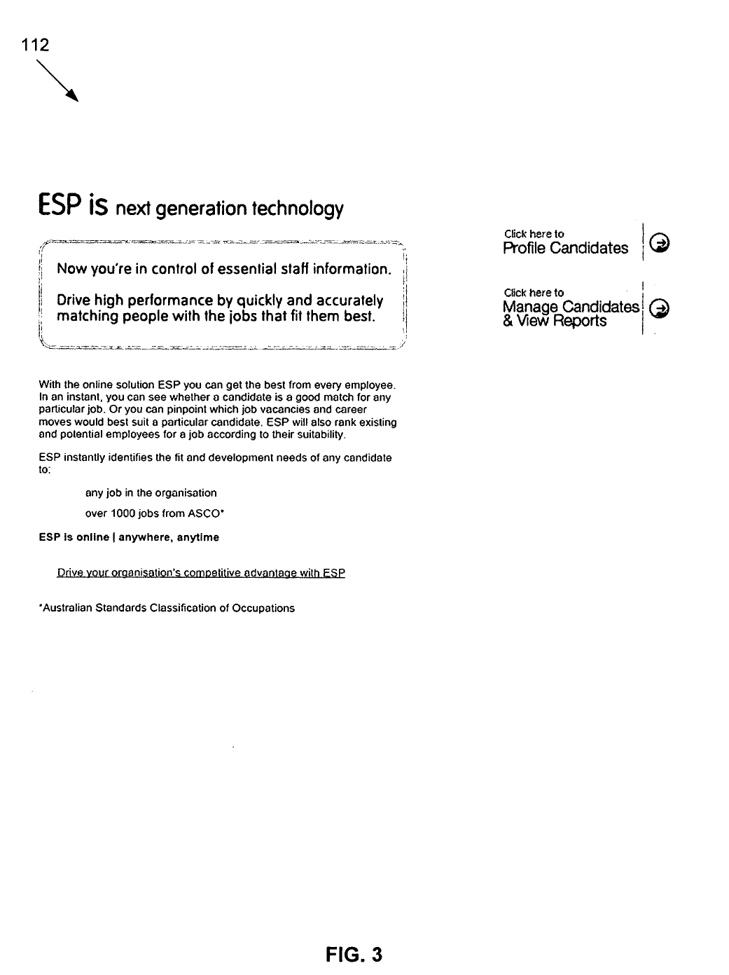

An exemplary user interface of Profile Management Module 112 is shown in FIG. 3. To allow an organisation to make full use of the features of the system 100, a job profile (a description of the job) can be created for all jobs across the organisation. Job profiles, may be created with the help of a psychologist or human resource expert.

A job 220 is defined by a title, an organisation name, an office, a job type and a task level. A job type may be generic or employer-specific and only employer-specific jobs are mapped to an organisation 200 and an office 210. Generic positions are used to provide career guidance to individuals while employer-specific positions describe actual jobs. A job is further categorised according to a job level which in turn corresponds to a particular task level either skilled or professional. For example, a job may be mapped to one of the following job levels: unskilled; semi-skilled; skilled operator or traders; supervisors or highly technical traders; junior managers or professionals; middle managers or professionals; and senior managers.

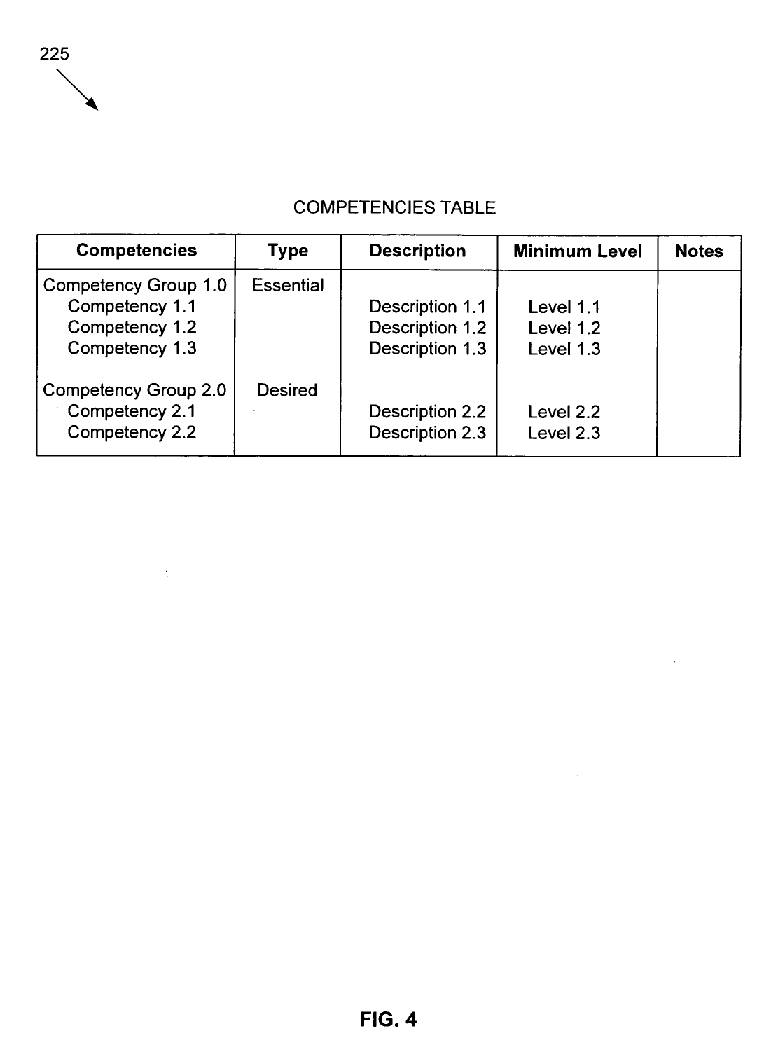

A job 220 is further characterised by competency requirements captured using a competency table shown in FIG. 4. Each competency is defined by its type (essential or desirable), description and minimum competency level. For example, the role of a business development manager requires essential competencies like commercial focus, persuasion and sales creation while organising may only be desirable, but not essential. Related interests may also be mapped to a job.

Each job 220 may be assigned to one or more groups 230, each identified by a name and each visible to different user types. For example, a job may be categorised into one or more groups that define the job type or the necessary qualification. An organisation may have job groups such as Admin Group, IT Group and Accountant Group. Organisation-specific job codes or standard job codes such as the Australian Standard Classification of Occupations (ASCO) codes may also be used to classify jobs. Where there are multiple classification systems, the system may support code mapping among the classifications. Besides job profiles, a profile can be created for every potential or existing employee in an organisation. Each candidate profile 240 is mapped to an organisation 200, an office 210, a task level and the following fields:
Estimated Duration to indicate the estimated time a candidate needs spend on completing tasks based on the Task Level.
Report Status to indicate whether there is an assessment outcome for a candidate.
Communication skills to capture a task administrator's or an interviewer's observation of the candidate's listening and verbal communication skills.
Profile notes to record comments on the candidate.
Session details to record the assessment details and results of the candidate.
Temperament profiles to record temperament characteristics of the candidate based on, for example, the Humm-Wadsworth Temperament Scale.

A candidate 240 may be mapped to one or more groups 230 to represent characteristics such as their role and qualifications. For example, a candidate may be mapped to a job-based group such as the Accountant Group and also a qualification-based group such as CPA Group. Further, interests of a candidate may be assessed and recorded.

### Profiler Module 114

The Profiler Module 114 is used by job seekers, students or anyone from the general population wanting career guidance, they may be existing or potential employees. Such a candidate needs to first logon to the system 100 and once authenticated, the Profiler Module 114 loads tasks 250 that have been assigned to the candidate. The interface of the invention may change for different types of users. For example, self-service candidates require more detailed instructions and structured feedback whereas individuals assessed under proctored condition require less advice as they can gain assistance from the task administrator.

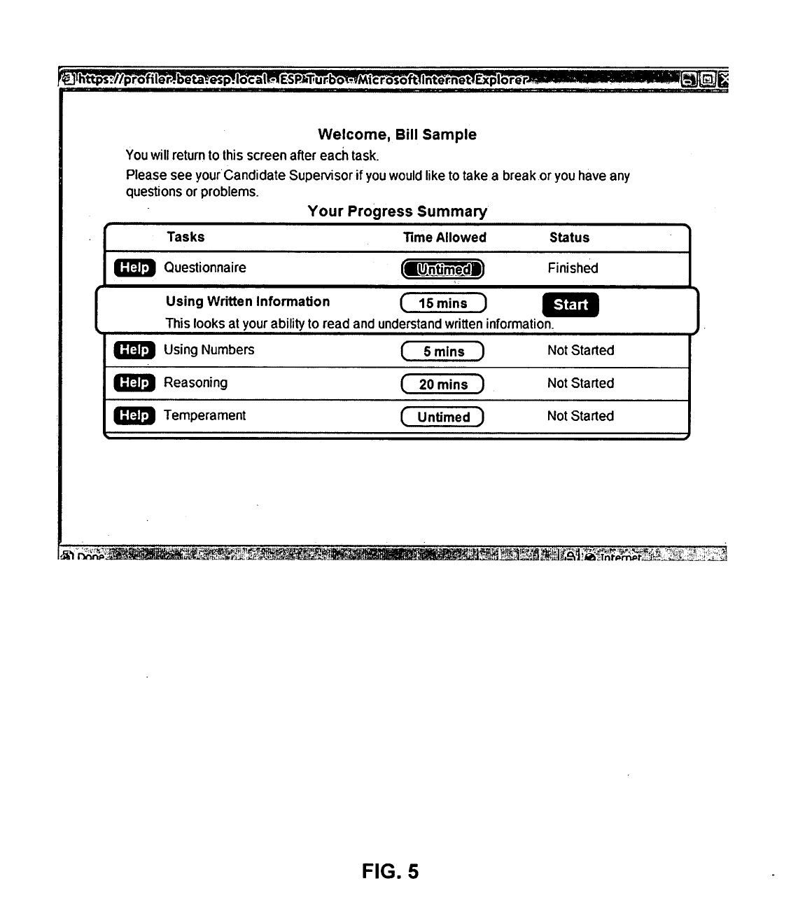

An exemplary task summary page is shown in FIG. 5. A task is identified by a name, description, task type (assessment or non-assessment), status (not started, in progress, in difficulty, finished or inactive), time allowed and time remaining. One or more tasks 250 may be then assigned to a candidate 240.

Tasks are categorised into non-assessment and assessment tasks. Non-assessment tasks include questionnaires and training exercises. While results from a training exercise are not recorded, except in terms of whether the candidate completed it or not, some results from the questionnaire are used to calculate the candidate's competency results while others are recorded for research purposes only.

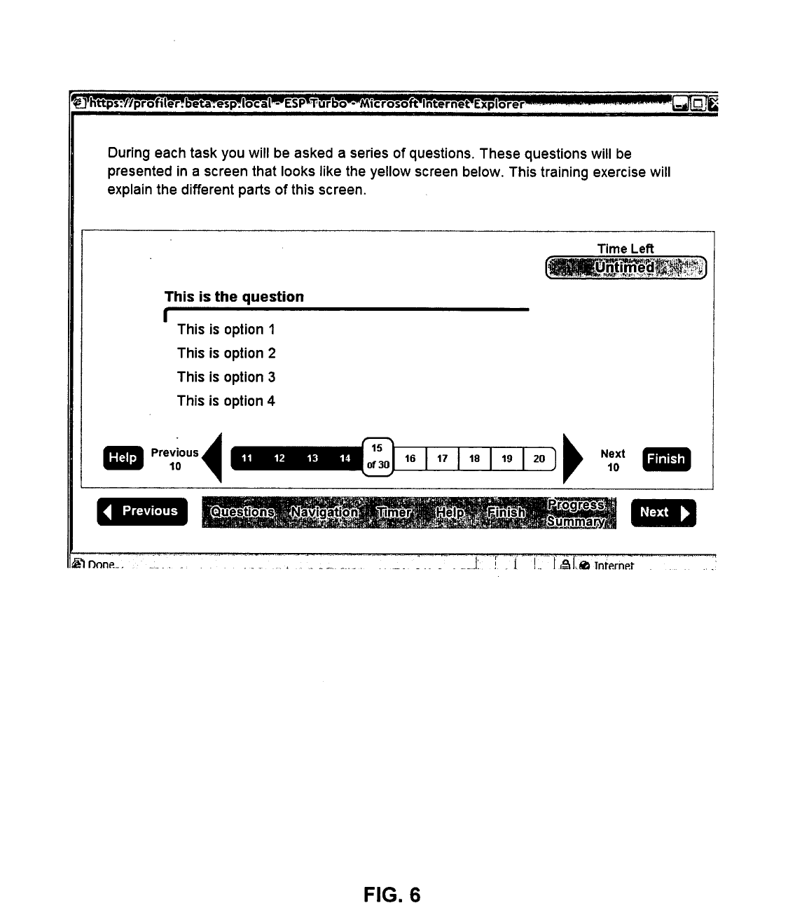

Referring to FIG. 6, a training exercise comprises plural practice questions to help a candidate to prepare for real assessment tasks. During the course of a training exercise, the Profiler Module 114 provides a candidate with instantaneous feedback on whether an answer selected is correct or otherwise. If a candidate repeatedly provides an incorrect answer, the Module 114 will direct the candidate to their task administrator so that they may make an assessment of the candidate's ability (either in terms of computer or English literacy skills) to complete the assessment tasks.

Assessment tasks are tests that are designed to assess a candidate's ability and temperament. Each task comprises one or more questions and answer choices and in some tasks questions are grouped into one or more subtasks. A question may require more than one answer. At the beginning of each ability assessment task sample questions for the candidate to practice on are provided. If a candidate provides an incorrect answer to these practice items they are provided with hints on how to answer it. However, if they repeatedly answer the question incorrectly the candidate will be administered an exercise to train them in how this type of question/problem works. This way the system ensures that each candidate understands what they must do for a particular assessment task before they begin the assessed (or evaluated) component of the task.

Assessment tasks maybe conventional tests where the same questions are administered to all candidates. Alternatively, questions may also be selected via a structured process from a pool of questions. In this case the same set of questions are not administered to all candidates. Rather candidates will be administered different sets of pre-programmed ‘strings’ of questions. The candidate's experience will remain unchanged since they will still receive what looks like a conventional test. However, each candidate will receive a different item string thus enabling these tests to be administered unproctored as each candidate receives a slightly different set of questions. Furthermore, unlike some existing conventional tests, by using item response theory rather than classical test theory methods to analysis the item pool it is possible to produce tests that are more precise in terms of their measurement accuracy. The results of an assessment task and the time spent on the task will be recorded and the results used as a measure of a candidate's competencies. A candidate profile may be automatically set to expire at a certain time after the profile is created.

Once all tasks for a particular session have been completed, the status of the session will be set to “finished” and the reports become available.

However, the report status of a candidate and consequently the availability of a candidate's reports can vary according to statistics collected during an assessment. The report status may be made available, but with consultant warning or a report warning, or both. Alternatively the report may be “held for review” and not available to the user until reviewed by a psychologist. For example, if the time spent on a temperament task is shorter than a predetermined period of time, e.g. 7 minutes, there maybe some doubt over the accuracy of the results and the report status will be automatically set to “held for review”.

Additional statistics maybe included if the assessment is administered unproctored. For example, algorithms maybe included that provide an estimate of the results reliability. These statistics would in turn trigger a warning to inform a potential employer of the risks involved with the unproctored testing as well as an estimate of whether the candidate's result was reliable. Unreliability maybe due to candidates trying to circumvent an unproctored test (e.g., by soliciting external help) or due to poor test environment conditions.

Once an assessment task is completed, the Profiler Module 114 compiles and stores a list of statistics collected under the Session Details field in a Candidate Profile. For example, some of the statistics of interest are the time spent on the task, number of attempted questions, number of correct answers and comparison of a candidate's scores with a norm group.

Based on statistics collected during the non-assessment tasks, assessment tasks and from other sources, such as the task administrator's or an interviewer's observations, the system uses a series of “interpretation algorithms” to derive a candidate's result for each competency. Once derived the candidate's competency results can then be compared to the competency requirements for various roles.

### Career Guidance, Training and Development

A career advisor or HR manager may then use the Profile Management Module 112 to provide career advice to a candidate based on their competencies and interests.

For a particular candidate, the Module 112 provides the following reports:
Candidate Strengths Report, which outlines a candidate's competency strengths;
Job Options Report, which provides a list of all or selected of jobs based on the job's fit with the candidate's competencies; and
Job Fit and Development Report, which indicates how well a candidate fits with a specific job and indicates and gaps requiring training and development.

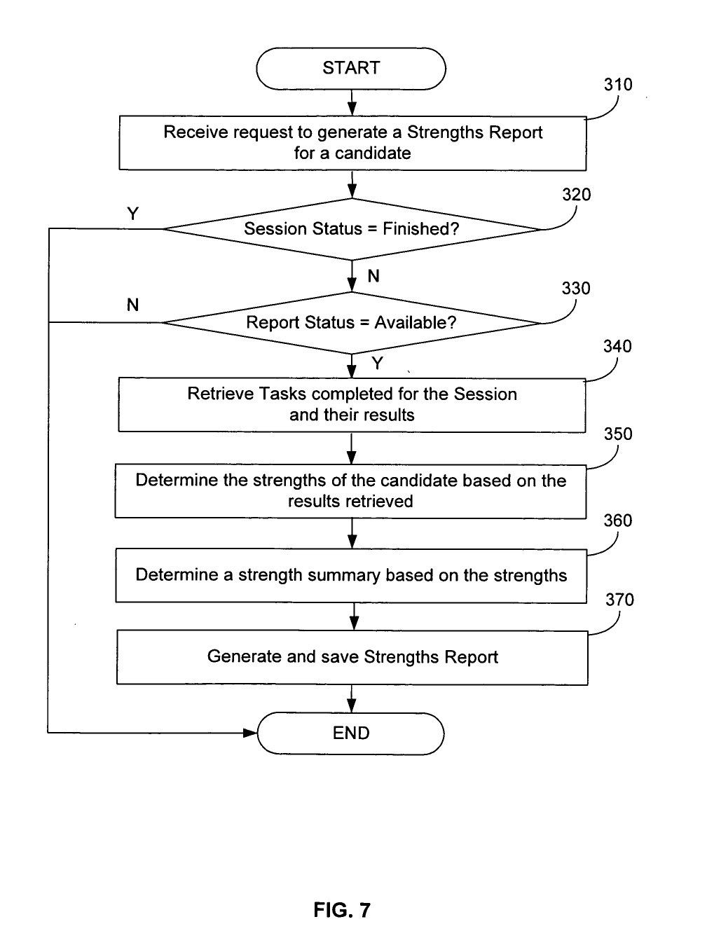

Referring now to FIG. 7, the Module 112 first checks the session status and report status of a candidate upon receiving a request to generate a Job Strengths Report; see 310, 320 and 330. If the Session Status is finished and the Report Status is available, the Module 112 will then retrieve the results of the tasks completed; see 340. The report may be with or without a warning. Next, the strengths of the candidate and a summary are determined based on the assessment results; see 350 and 360. Finally, the Module 112 will generate the report and send it to the requester. Using this report, a career advisor is able to help a candidate understand their competency strengths and show them they have skills that employer's value.

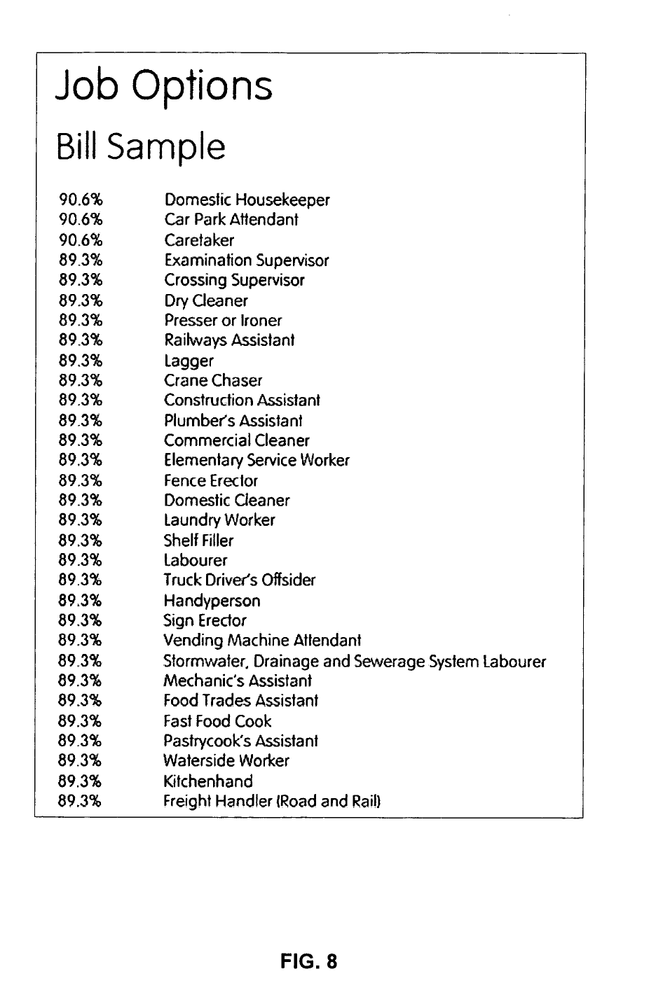

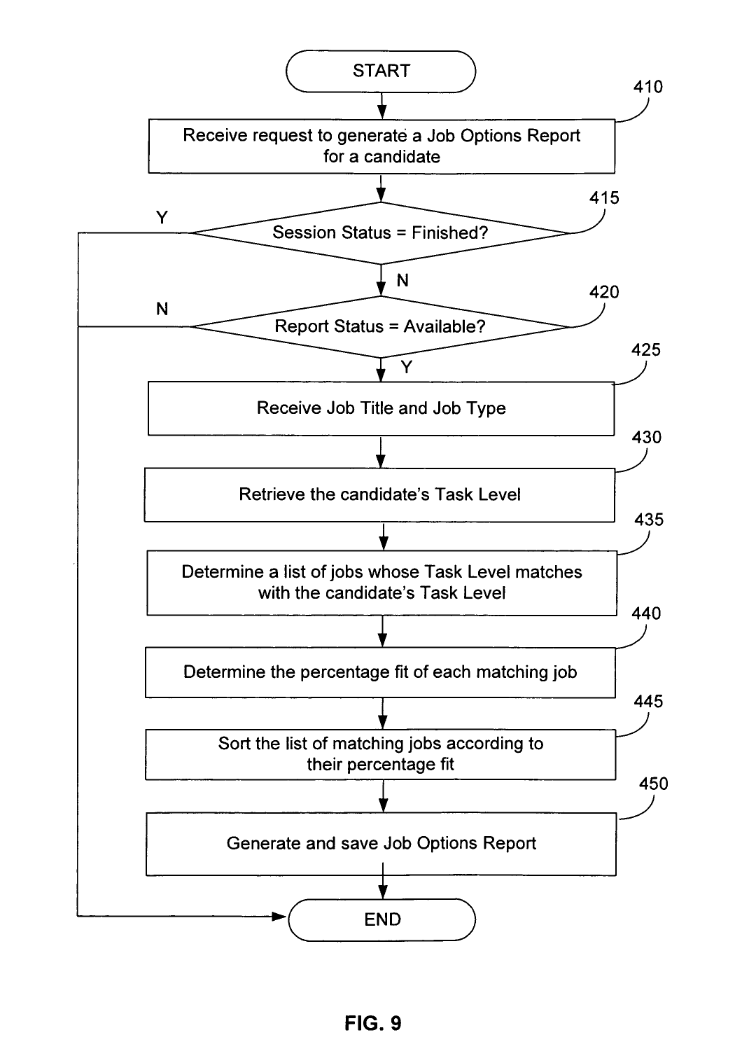

Referring to FIG. 8, a Job Options Report provides a one-to-many mapping between a candidate and a list of jobs based on the competency requirements of the job and the competency results of the candidate. Jobs are listed in descending order according to the candidate's degree of fit with each job. As shown in the report generation flowchart in FIG. 9, the Module 112 first checks that the Session Status and Report Status of the candidate are finished and available respectively; see 410, 415 and 420. The report may be with or without a warning.

The user is required to initiate a search. The Module 112 then determines a list of jobs whose Task Level matches with the candidate's Task Level and their percentage fit with the candidate; see 430, 435 and 440. For example, if a candidate has completed tasks of the professional level, only professional jobs will be included. The percentage fit is an index of a candidate's fit with the competencies for the job, this index takes into consideration both whether the competency is essential or desirable and the size of any competency gaps.

The matching jobs are then sorted according to their percentage fit and depending on the number of jobs (N) requested, only N jobs will be featured in the report. Note that the jobs may be generic or employer-specific. For example, school leavers who are only assessing potential job options may prefer to search for matching generic jobs. By contrast, a current employee may only be interested in jobs available within their organisation.

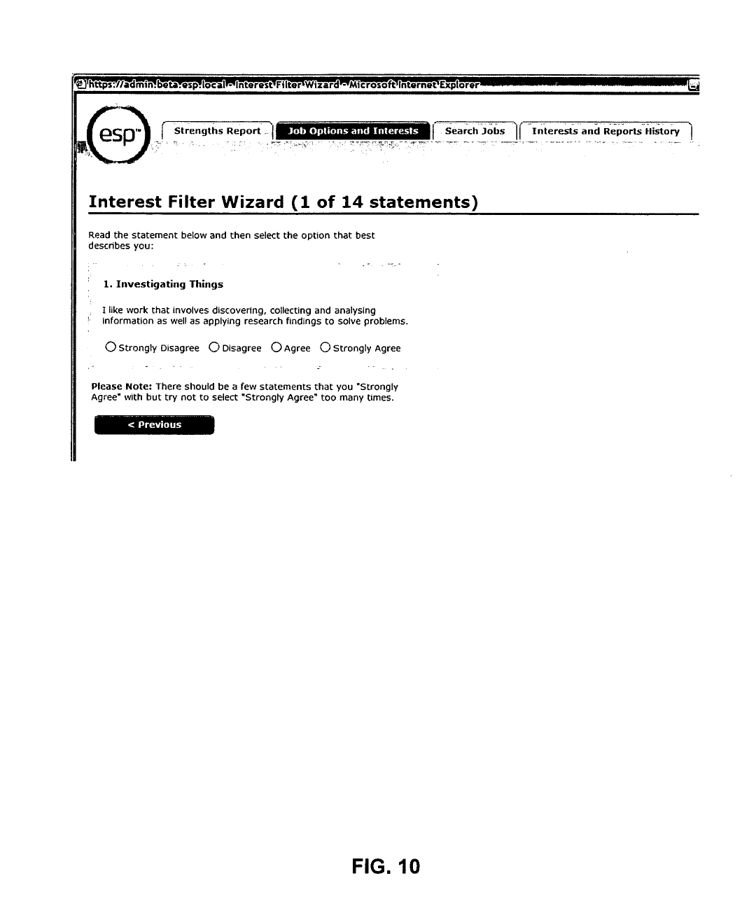

The list of matching jobs can then be further filtered according to a candidate's interests. For example, for an accounting position, the candidate is expected to be interested in working with numbers. The interests of a candidate may be determined using an interests selection wizard. An exemplary interest filter wizard interface is shown in FIG. 10. A series of interests items are presented to a candidate, who is then required to select whether they strongly agree, agree, disagree or strongly disagree that the interest statement presented describes them. Strongly agree should be picked at least once. Then, based on the candidate's selection, interests that the candidate strongly agrees with will be recorded as their selected interests (though rules are provided if a candidate does not select strongly agree at least once or selects it too many times).

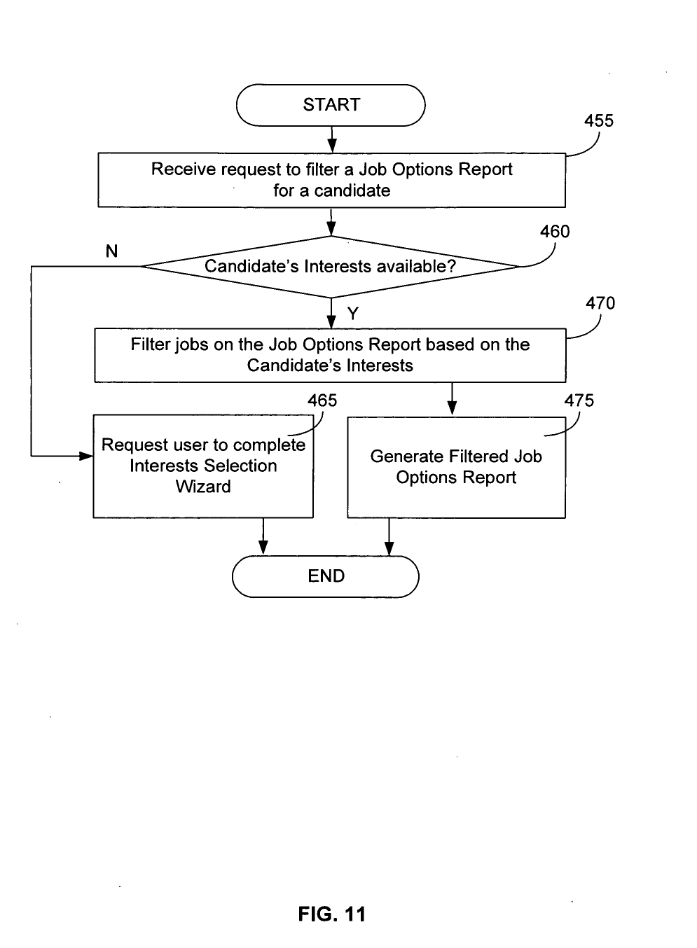

Alternatively, a candidate may select one or more interests from a list without using the interest filter wizard. FIG. 11 shows a process flowchart of generating a filtered Job Options based on interests. The list of jobs, sorted according to their percentage fit are then filtered according to the selected interests. The candidate may also further edit their interests selection to discover how this will impact on the jobs shown and help them to fully explore their career options.

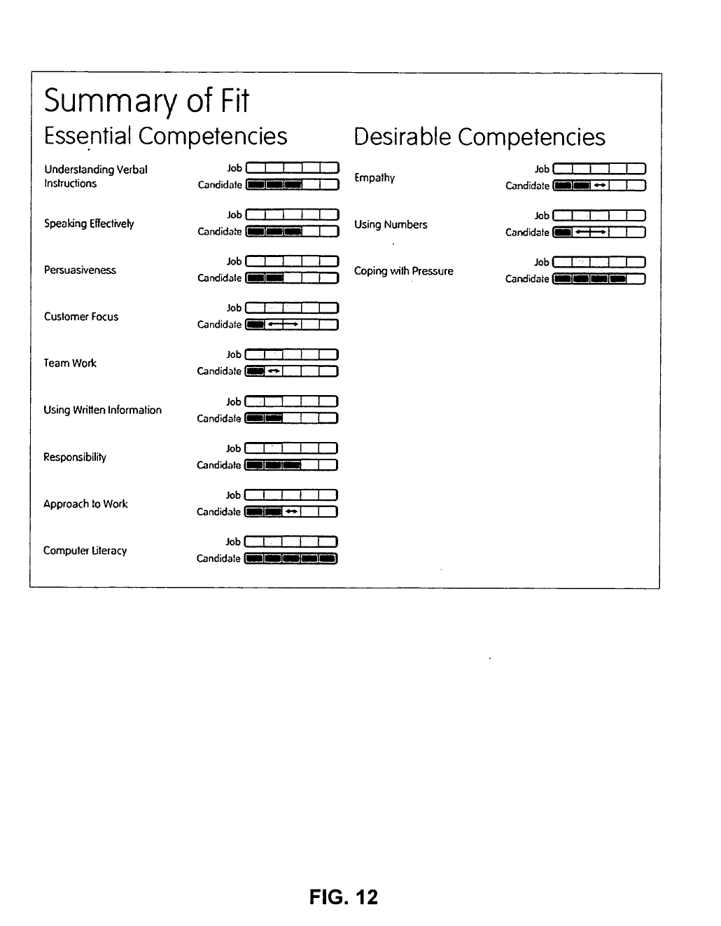

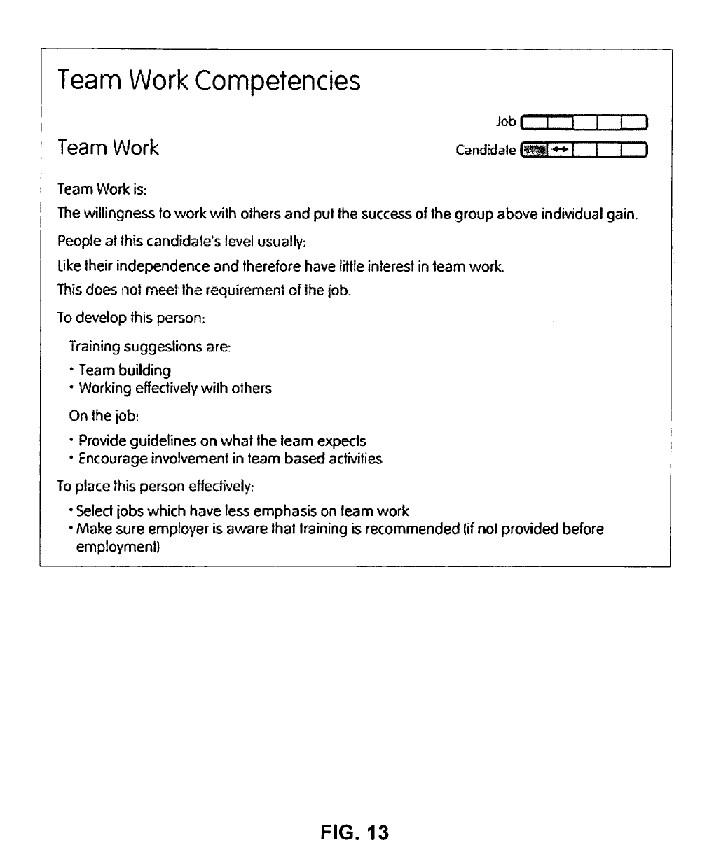

A Job Fit and Development Report provides a one-to-one mapping between a candidate and a specific job and identifies the competency gaps between them. A sample Job Fit and Development Report is shown in FIG. 12. This report provides a full breakdown of the candidate's fit with each of the individual competencies allocated as either essential or desirable for the particular job. This breakdown may provide a description of each competency, a description of the candidate's result on that competency, a section outlining interview and referee questions, as well as development and placement advice for were there is a competency gap. The competency requirements of the job are compared with the competencies of the candidate. For example, as shown in FIG. 13, the report identifies a gap in a candidate's team working ability and provides suggestions on formal and on-the-job training. Using this report, a HR manager can design or select specific training programs for existing employees based on the competency gap identified.

### Recruitment

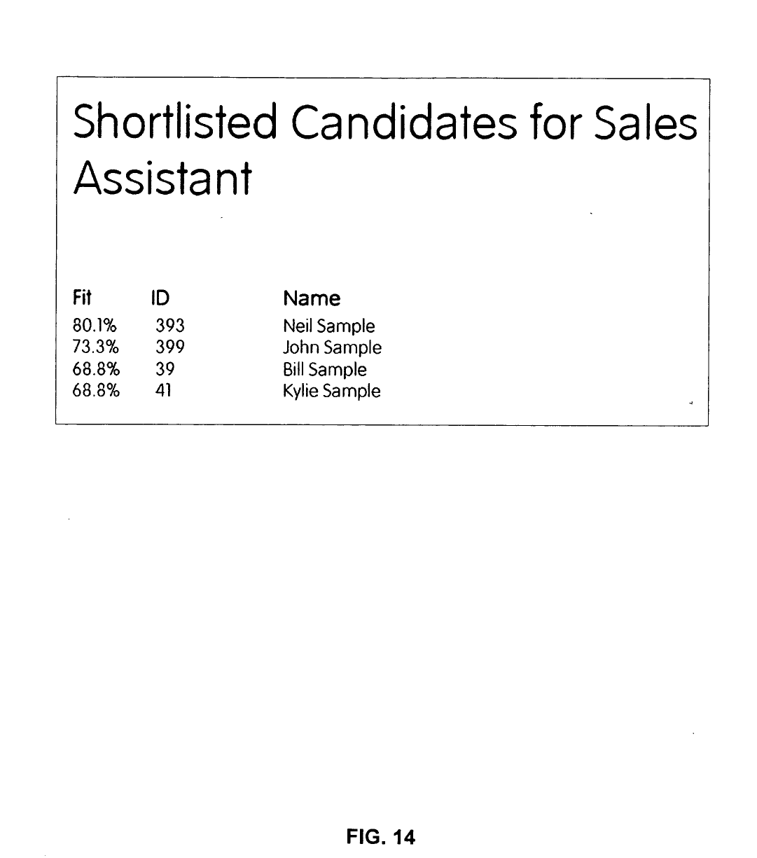

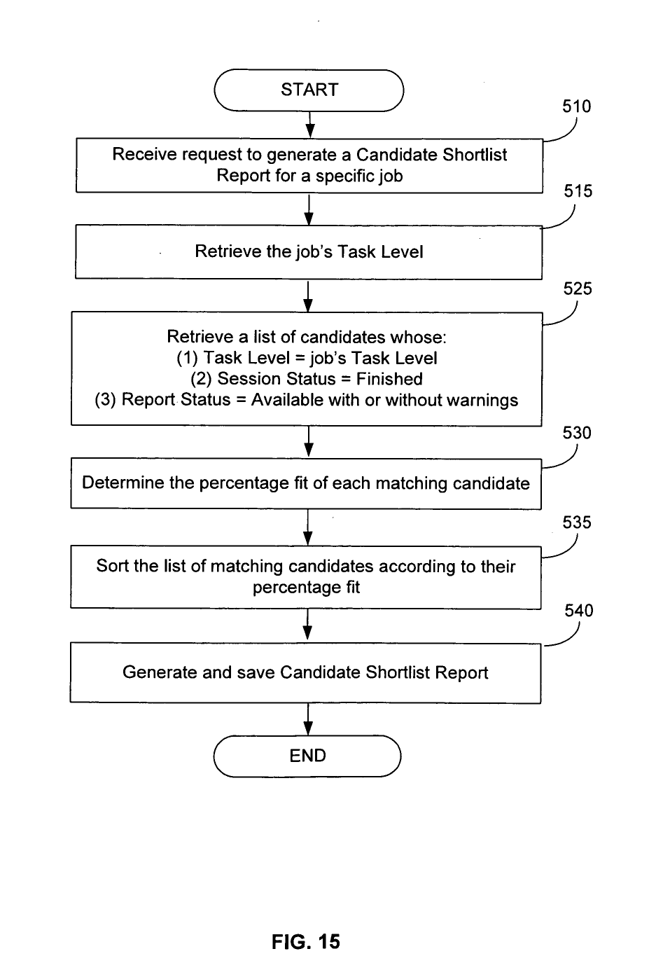

The Profile Management Module 112 also provides support to recruitment activities, especially in tracking and shortlisting candidates. Referring to FIG. 14, a Candidate Shortlist Report provides a one-to-many mapping between a specific job and plural candidates. FIG. 15 shows a process flowchart of generating a Candidate Shortlist Report. The Module 112 first determines the Task Level of the job and determines a list of candidates who have completed assessments for the same Task Level. For example, if the job is a managerial position, only candidates whose Task Level is professional will be assessed.

Next, the Module 112 then determines the percentage fit of each matching candidate and sorts the list of candidates according to their percentage fit. From the Shortlist Report, a recruitment manager may view the Job Fit and Development Report for each candidate to gain a more detailed view of their fit with the job.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A computer system for recruitment selection, personnel management and career guidance, comprising:
a database to store descriptions of jobs each of which is defined by competencies;
a database to store descriptions of candidates each of which is defined by competencies;
a processor operable to automatically report a ranked match between a single job and many candidates based on matching competencies, or to automatically report a ranked match between a single candidate and many jobs based on matching competencies; and,
a user interface to display the resulting report.

2. A computer system according to claim 1, where in a report of a ranked match between a single job and many candidates, candidates are ranked according to a percentage fit of their competencies with that of the single job.

3. A computer system according to claim 2, where in a report of a ranked match between a single candidate and many jobs, jobs are ranked according to a percentage fit of their competencies with that of the single candidate.

4. A computer system according to claim 3 where a report of a ranked match between a single candidate and many jobs is selectively filtered to show only results that match the candidate's interests.

5. A computer system according to claim 4, wherein the interests of the candidate are assessed by requesting the candidate to rate interests according to their preference for different types of work.

6. A computer system according to claim 5, wherein the candidate edits their interest preferences in real time to see updated reports.

7. A computer system according to claim 6 wherein the processor is operable to provide for each job a full breakdown of the candidate's fit with each of the individual competencies for that particular job.

8. A computer system according to claim 7 wherein the processor is further operable to report competency strengths of a single candidate.

9. A computer system according to claim 8 further comprising a user interface for candidates to take a number of assessment tasks.

10. A computer system according to claim 9, wherein at the beginning of an assessment task sample questions are provided to ensure the candidate understands what they must do before they begin the assessment.

11. A computer system according to claim 10, wherein the assessment tasks involve presenting the candidate with strings of questions selected via a structured process from a pool of questions.

12. A computer system according to claim 11, wherein item response theory is used to analysis the item pool to select each string of questions.

13. A computer system according to any preceding claim further comprising a user interface for creating and editing descriptions of jobs in the database in terms of competencies.

14. A computer implemented method for recruitment selection, personnel management and career guidance, comprising the steps of:
storing descriptions of jobs each of which is defined by competencies;
storing descriptions of candidates each of which is defined by competencies;
automatically reporting a ranked match between a single selected job and many candidates based on matching competencies, or automatically reporting a ranked match between a single selected candidate and many jobs based on matching competencies; and,
displaying the resulting report at a computer interface.

15. A software program to implement a method according to claim 14.
